(19) United States
(12) Patent Application Publication
(10) Pub. No.: US 2012/0290476 A1
(43) Pub. Date: Nov. 15, 2012

(54) ONLINE INFORMATION INPUT AND FINANCIAL TRANSACTION SYSTEM USING THE PERSONAL IDENTIFICATION MEDIA, METHODS TO INPUT INFORMATION ONLINE AND CONDUCT FINANCIAL TRANSACTIONS, AND THE STORING MEDIA THAT STORES THE PROGRAMS FOR THE SYSTEM

(76) Inventor: Seung Hun Yoo, Seoul (KR)

(21) Appl. No.: 13/522,972

(22) PCT Filed: Jan. 5, 2011
(86) PCT No.: PCT/KR2011/000055

§ 371 Date: Jul. 19, 2012

(30) Foreign Application Priority Data
Jan. 19, 2010 (KR) 10-2010-0004900

(51) Int. Cl. G06Q 40/02

(52) U.S. Cl. 705/42

(57) ABSTRACT

This invention is related to the online information input and financial transaction system using the personal identification media, which is intended to facilitate the information input process by utilizing the personal information registered with the personal information management institutions in signing up to be a member of, or logging in to, websites, and the methods to input information online and conduct financial transactions. In this invention, we intended the process of membership joining or logging-in to websites to be completed through transmitting the personal identification data read by the media reader to the personal information management institutions and then receiving the member's personal information or the personal authentication services, and also helped minimize the user's information input by integrating the log-in and payment processes. This invention has merits in that it facilitates the membership-joining, log-in and payment processes, and the amount of the information the user has to input is minimized.

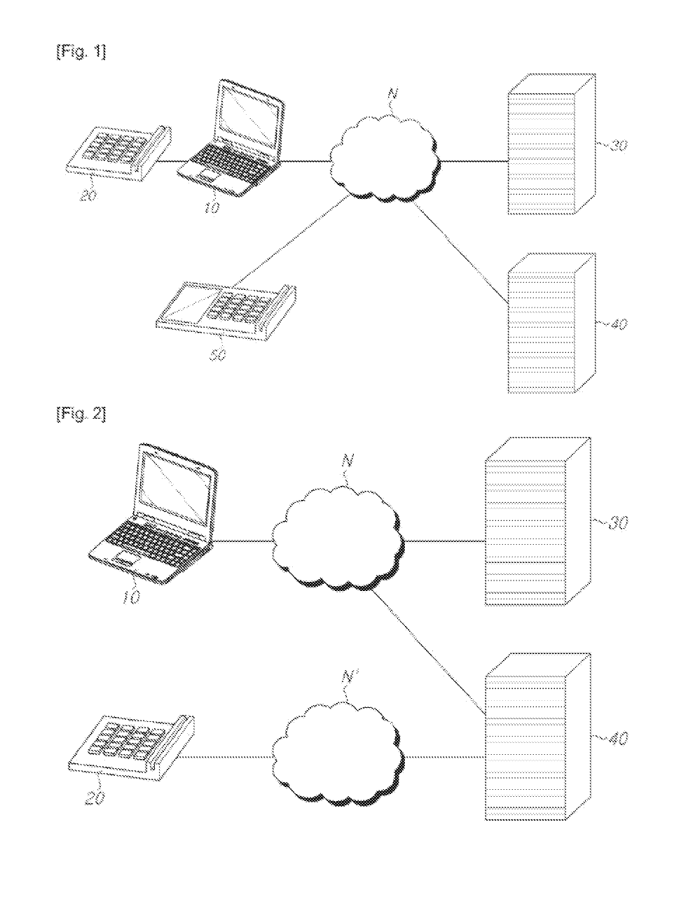

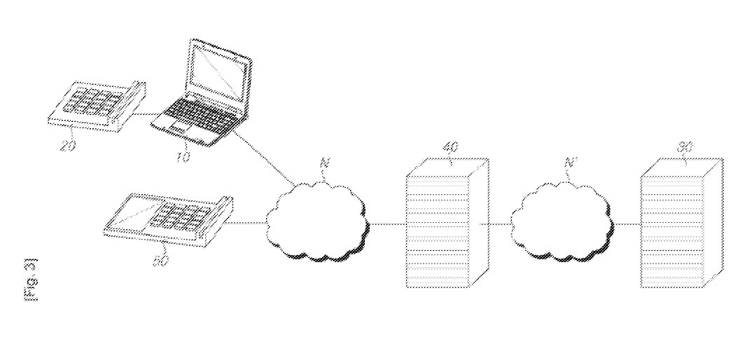

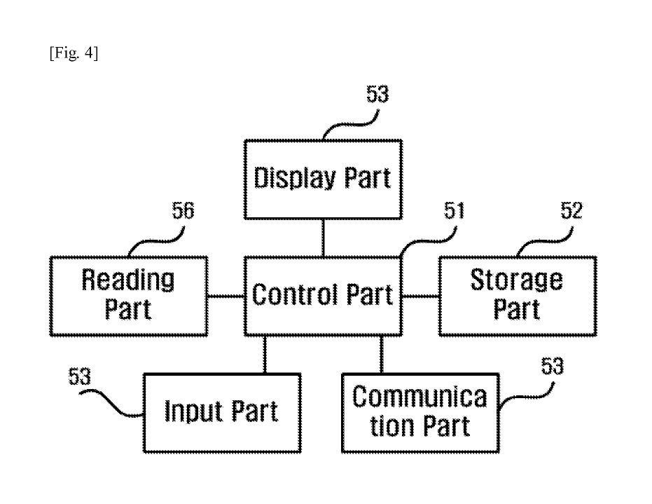

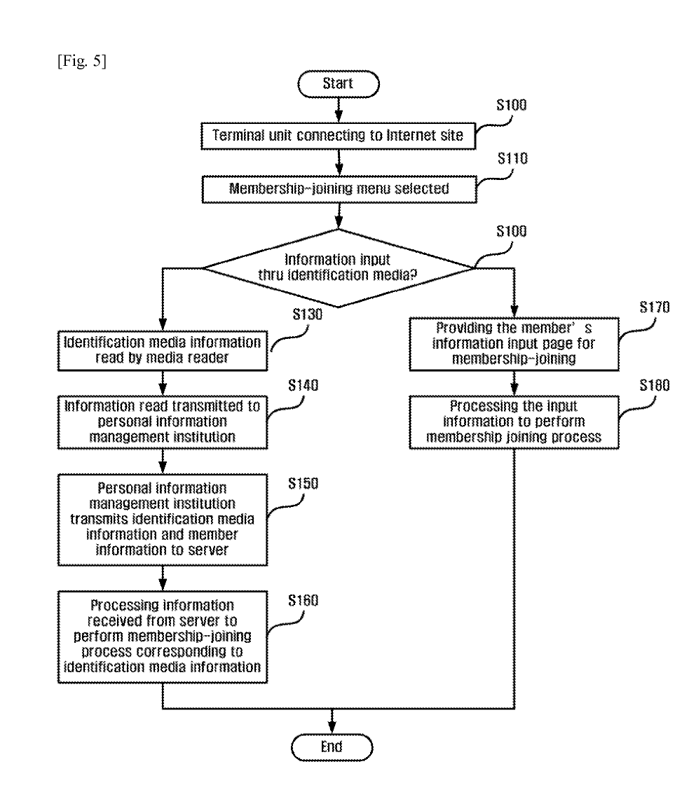

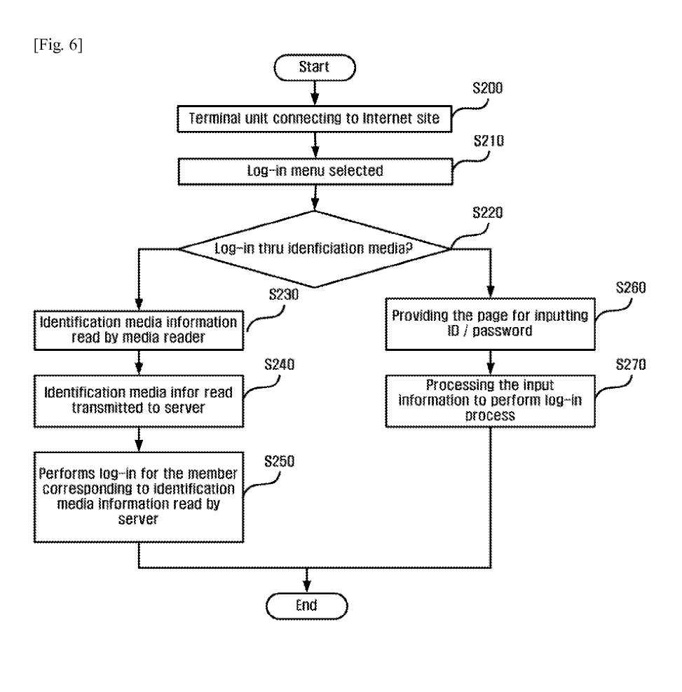

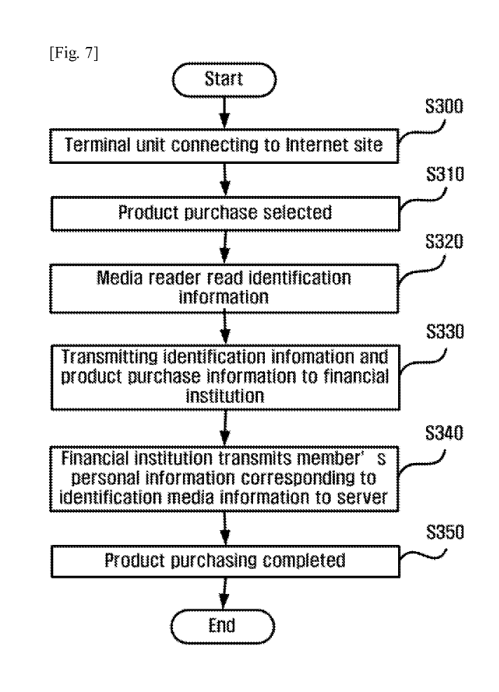

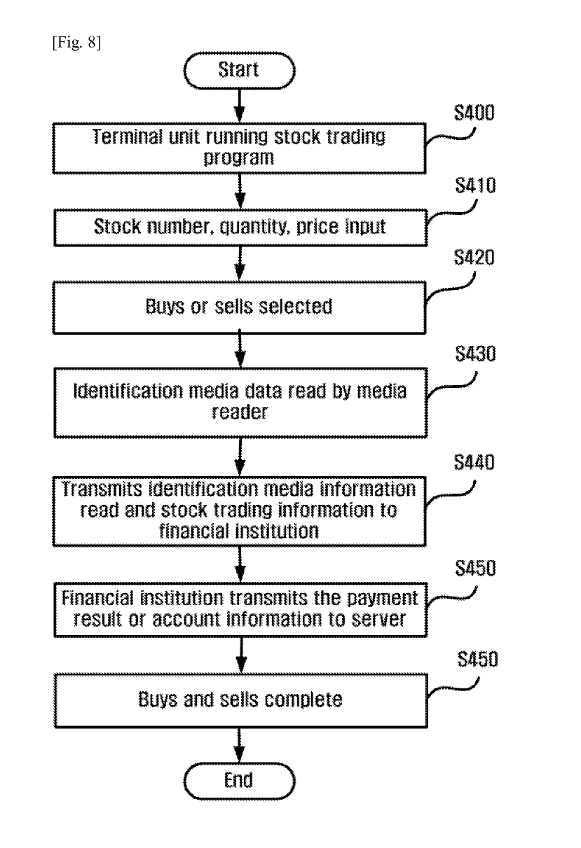

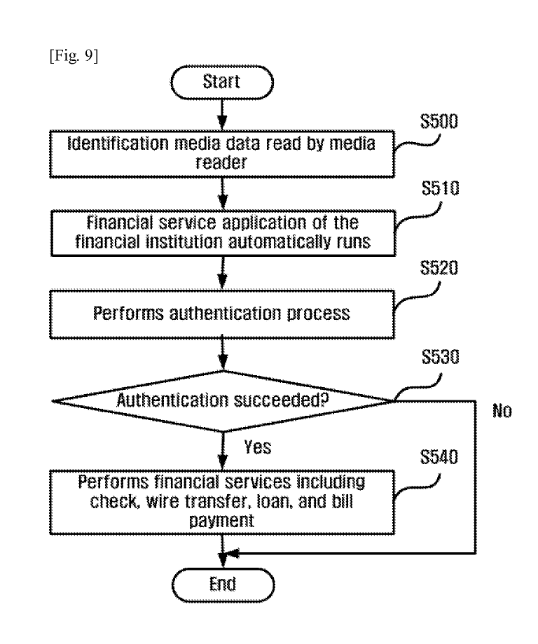

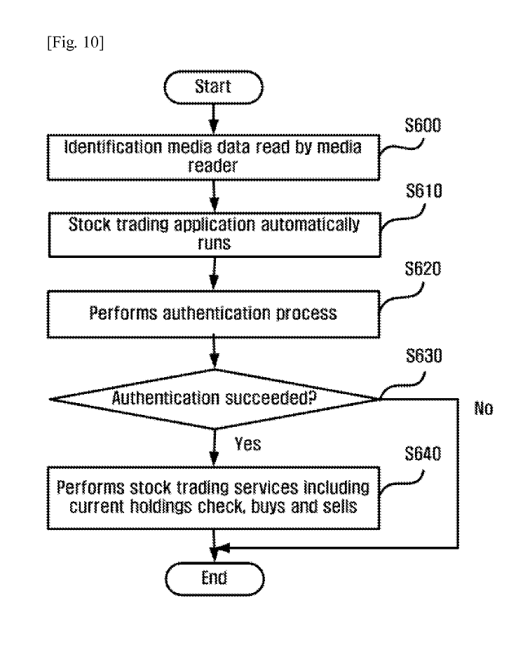

### FIELD OF THE INVENTION

This invention is related to the online information input and financial transaction system using the personal identification media, and the methods to input information online and conduct financial transactions. Specifically, this invention is about the online information input and financial transaction system using the personal identification media which is intended to facilitate the information input and payment processes by utilizing the personal information registered with the personal information management institution in signing up to be a member of, or logging in to, websites through the personal identification media, and the methods to input information online and conduct financial transactions using the system.

### BACKGROUND ART

With the development of the electronic commerce technologies, an increasing quantity of products, contents, stocks, etc. is being traded online. In order for the e-commerce users to purchase such products online, however, they have had to sign up for a membership of each website selling such products and, with the websites for which they are already a member, log on to the site to finally go through the complex payment procedures. Becoming a member of a website involved cumbersome procedures of inputting a serious of personal information such as ID, password, name, resident registration number, address, and any other information required, and the users needed to input such information over to use a new website. Furthermore, as the membership check system, IDs, and passwords may be different from site to site, having to recollect the specific personal information for each site has also been a troublesome procedure. As the payment system also required the membership joining or logging-in procedures before the complex payment process, there has been a call for a simplified process that enables the e-commerce users to complete payment without membership joining or logging-in procedures as in an off-line purchase, or for a more simplified system that incorporates the entire procedures of membership-joining, logging-in, and payment processes.

As for the payment process itself, online payment requires the input of the serial number, password, expiration date, and CVC (Card Verification Code), etc., while, in an off-line purchase, simply swiping the card in the card reader completes the whole procedures. Therefore, there has been a natural call for a system that can reduce these cumbersome procedures.

For a financial service, the customers could use their PC or mobile phone to receive a service instead of directly visiting a financial institution, but this type of service also requires the inconvenient procedures of online membership-joining, logging-in and authentication processes.

### SUMMARY OF THE INVENTION

### Technological Goals

This invention, therefore, is intended for helping relieve the above-mentioned traditional inconveniences. It aims to provide a simplified online information input and financial transaction system using the personal identification media by which the card reader is used as in the payment for an off-line purchase, and the methods to input information online and conduct financial transactions.

Another purpose of this invention is to provide an online information input and financial transaction system using the personal identification media by which the membership joining and logging-in procedures are completed using the personal information registered with the personal information management institution or the personal authentication process provided by the personal information management institution, and the methods to input information online and conduct financial transactions.

Another purpose of this invention is to provide an online information input and financial transaction system using the personal identification media by which additional personal authentication and complex payment procedures can be reduced in signing up for a membership of, or logging in for, websites by going through the personal identification process provided by the personal information management institution, and the methods to input information online and conduct financial transactions.

Another purpose of this invention is to provide the methods to input information online and conduct financial transactions using the personal identification media by which online financial services or stock trading process could be simplified through using the personal identification media and the related reader.

### Technical Solution

As for the characteristics of this invention in terms of achieving the above-mentioned goals, this invention, the online information input and financial transaction system using the personal identification media, consists of at least one personal terminal unit that is directly connected to the network and capable of communicating with the servers connected to the network; the media reader that is installed to the foregoing network and retrieves and transmits the personal identification data stored in the personal identification media to the foregoing personal terminal unit; at least one website server that provides the web pages contained in the websites to at least one personal terminal unit; and the server of the personal information management institution that stores the member's personal information corresponding to the foregoing personal identification data and conducts the payment procedure for the designated member upon receiving the payment request from the foregoing website. Upon receiving from the foregoing personal terminal unit the personal identification data retrieved by the foregoing media reader, the server of the foregoing website compares and searches the personal identification data that match the personal identification data already stored in the server of the foregoing website, and conducts the membership log-in procedure provided by the server of the foregoing website by using the personal membership information corresponding to the personal identification data searched, and in the event no personal identification data received from the foregoing personal terminal unit is found among the personal identification data already stored in the server of the foregoing website, then the system transmits the request for the foregoing personal identification data and the personal membership information corresponding to the foregoing personal identification data to the server of the foregoing personal information management institution, and conducts the membership log-in procedure by using the personal membership information received from the foregoing personal information management institution, whereas, upon receiving the request for the foregoing personal identification data and the personal membership information corresponding to the foregoing personal identification data from the foregoing website, the server of the personal information management institution provides the personal membership information corresponding to the foregoing personal identification data to the server of the foregoing website.

And in case no personal identification data received is found among the personal identification data already stored in the server of the foregoing website, then the server of the foregoing website receives the password corresponding to the very personal identification data from the foregoing personal terminal unit, transmits to the server of the foregoing personal information management institution the foregoing password together with the foregoing personal identification data and the personal membership information corresponding to the foregoing personal identification data, whereas the server of the foregoing personal information management institution can provide to the foregoing website the personal membership information corresponding to the foregoing personal identification data only when the password match that of the personal identification data received.

And the server of the foregoing website receives from the foregoing personal terminal unit the personal identification data and the password matching that of the foregoing personal identification information retrieved from the foregoing personal terminal unit, transmits to the server of the personal information management institution the personal authentication request including the foregoing personal identification data and the foregoing password, conducts the membership log-in procedure only when the personal authentication is successfully completed by the server of the personal information management institution, whereas the server of the personal information management institution may transmit the result of the personal authentication to the foregoing website server after receiving the foregoing personal identification data and the foregoing password from the server of the foregoing website and conducting the personal authentication process.

Furthermore, upon receiving a product purchase order from the foregoing personal terminal unit, the server of the foregoing website transmits the server of the personal information management institution the information related to the purchase case including the price and installment period, the foregoing personal identification data, and the foregoing password to request payment for the case, whereas the server of the personal information management institution makes payment using the information related to the purchase case, the foregoing personal identification data, and the foregoing password and may transmit the result of the payment to the foregoing website server.

On the other hand, this invention, the online information input and financial transaction system using the personal identification media, consists of at least one personal terminal unit that is directly connected to the first network and capable of communicating with the servers connected to the first network; at least one media reader that is directly connected to the second network and capable of communicating with the servers connected to the second network, and retrieves the personal identification data stored in the personal identification media; at least one website server that provides the web pages contained in the websites to at least one personal terminal unit; and the server of the personal information management institution that stores the member's personal information corresponding to the foregoing personal identification data and conducts the payment procedure for the designated member upon receiving the payment request from the foregoing website. Upon receiving from the foregoing personal terminal unit either the membership joining request, log-in request, or payment request, the server of the foregoing website transmits the webpage and authentication number for the selection of the personal information management institution, and, upon the selection of the agency by the foregoing personal terminal unit, transmits either the membership joining request, log-in request, or payment request along with the authentication number to the server managed by the personal information management institution selected. Meanwhile, upon receiving from the foregoing website server either the personal information request, personal authentication request, or payment request along with the authentication number, and the personal identification data and the authentication number from the foregoing media reader, the server of the foregoing personal information management institution, in case the authentication number received from the foregoing website server matches the number received from the foregoing media reader, accepts either the personal information request, personal authentication request, or payment request using the personal identification data transmitted along with the matching authentication number to conduct the responsive payment process and may transmit to the foregoing website either the personal information, the result of the personal authentication, or the payment result.

The server of the foregoing personal information management institution receives from the foregoing media reader the foregoing personal identification data, the foregoing authentication number and the password corresponding to the foregoing personal identification data, and accepts either personal information request, personal authentication request, or payment request to conduct the responsive process only when the foregoing personal identification data match the foregoing password.

The foregoing first network as used herein may refer to the Internet, and the foregoing second network may refer to the Internet, VAN (Value Added Network) or PSTN (Public Switched Telephone Network).

This invention may be performed in the stages of (A) receiving either the membership-joining request, request for the change to the member information, or log-in request from the personal terminal unit; (B) receiving from the foregoing personal terminal unit the personal identification data retrieved by the media reader and the password corresponding to the foregoing identification data; (C) transmitting to the server of the foregoing personal information management institution the personal identification data and password received, and the request for the personal information or the personal authentication; and (D) upon receiving the personal information or the result of the personal authentication from the server of the foregoing personal information management institution, conducting the membership-joining or member information change procedures using the personal information received or conducting a log-in only when the personal authentication is successfully completed.

The methods of inputting the foregoing online information and conducting financial transactions may be performed in the stages of (E) receiving a purchase order from the foregoing personal terminal unit; (F) determining the current logged-in/logged-out status of the foregoing personal terminal unit that placed the purchase order; (G) in case the foregoing personal terminal unit is in a logged-in status, transmitting to the server of the foregoing personal information management institution the payment request including the personal identification data and password received in the foregoing (B) stage, and the payment-related information such as the price and installment period; (H) in case the foregoing personal terminal unit is in a logged-out status, receiving from the foregoing personal terminal unit the personal identification data and the password corresponding to the foregoing personal identification data; (I) transmitting to the server of the foregoing personal information management institution the payment request including the personal identification data and password received in the foregoing (H) stage, and the payment-related information such as the price and installment period; and (J) in response to the payment request transmitted in the foregoing (G) or foregoing (I) stage, reflecting the result of the product purchase as per the payment result received from the server of the foregoing personal information management institution and transmitting the purchase result to the foregoing personal terminal unit.

In the foregoing stage (I), adding to the foregoing request for payment, the request for the personal information including the name and address of the member corresponding to the foregoing personal identification data is also transmitted, and, in the foregoing stage (J), the personal information of the member received together with the result of the foregoing payment result may be reflected as the delivery information upon the result of the product purchase only in case the foregoing request for the personal information is transmitted to the server of the foregoing personal information management institution.

This invention may be performed in the stages of (1) receiving by the server of the foregoing website the request for either membership joining, change of the member information, or log-in from the personal terminal unit; (2) upon receiving the request for either membership joining, change of the member information, or log-in from the foregoing personal terminal unit, transmitting by the server of the foregoing website to the personal terminal unit the webpage and authentication number that enable the selection of the personal information management institution; (3) transmitting to the server of the foregoing personal information management institution the information including the personal identification data retrieved from the media reader, the password corresponding to the foregoing personal identification data, and the authentication number; (4) transmitting to the server of the personal information management institution the request for the personal information or the personal authentication that include the same authentication number as the one the foregoing website server provided to the foregoing personal terminal unit in the foregoing (2) stage; (5) in case the authentication number included in the information the server of the personal information management institution received from the foregoing media reader matches the authentication number received from the foregoing website server, providing the personal information or the result of the personal authentication to the server of the foregoing webpage after searching the personal information of the member using the personal identification data and password included in the information matching the authentication number or conducting the personal authentication process;

And (6) conducting by the server of the foregoing website the membership joining, member information change or log-in procedures based on the personal information or the result of the personal authentication.

As for the method of the online information input and financial transactions, this invention may be performed in the stages of (7) receiving by the server of the foregoing website the purchase order from the foregoing personal terminal unit; (8) determining by the server of the foregoing website the current logged-in/logged-out status of the foregoing personal terminal unit that placed the purchase order; (9) in case the foregoing personal terminal unit is in a logged-in status, transmitting by the server of the foregoing website to the server of the foregoing personal information management institution the payment request including the personal identification data and password received in the foregoing (3) stage, and the payment-related information such as the price and installment period; (H) in case the foregoing personal terminal unit is in a logged-out status, transmitting by the server of the foregoing website to the personal terminal unit the webpage and authentication number for the selection of the personal information management institution; (11) after the completion of the foregoing stage (10), transmitting to the server of the foregoing personal information management institution the information including the personal identification data retrieved from the media reader, the password corresponding to the foregoing personal identification data, and the authentication number; (12) transmitting to the server of the foregoing personal information management institution the same authentication number as the one the foregoing website server provided to the foregoing personal terminal unit in the foregoing stage (10) and the payment request that include the payment-related information such as the price and installment period; (13) in case the authentication number included in the information the server of the personal information management institution received from the foregoing media reader in the foregoing stage (11) matches the authentication number received from the foregoing website server in the foregoing stage (12), providing the payment result to the server of the foregoing webpage after conducting the payment process using the personal identification data and password included in the information matching the authentication number; and (14) reflecting by the server of the foregoing website the result of the product purchase as per the payment result received from the server of the foregoing personal information management institution and transmitting the purchase result to the foregoing personal terminal unit.

On the other hand, this invention, the online information input and financial transaction system using the personal identification media, consists of at least one personal terminal unit that is directly connected to the network and capable of communicating with the servers connected to the network; the media reader that is installed to the foregoing personal terminal unit and retrieves and transmits the personal identification data stored in the personal identification media to the foregoing personal terminal unit; the website server that provides the web pages contained in the websites to the foregoing personal terminal unit; and the server of the personal information management institution that stores the member's personal information corresponding to the foregoing personal identification data. With the foregoing media reader detecting the personal identification data stored in the personal identification media, the foregoing personal terminal unit can connect to the server of the foregoing website and automatically run the application provided from the server of the foregoing website, and, running on the application, transmit to the server of the foregoing personal information management institution the personal identification data retrieved by the foregoing media reader and the authentication information input by the user.

The server of the foregoing personal information management institution can conduct the authentication process by comparing the personal information already stored and the authentication information transmitted from the foregoing personal terminal unit for the member corresponding to the foregoing personal identification data transmitted from the foregoing personal terminal unit.

And after the authentication process by the server of the foregoing personal information management institution, the foregoing personal terminal unit interworks with the server of the foregoing website as per the application to provide to the user the financial services that include at least one out of the bank account statement, remittances, payments, credit card statement, and cash advance services, or the stock trading services including the details on the current stock holdings, buys and sells.

Meanwhile, this invention may include the storage media that stores the personal terminal unit-based program running in the stages of (a) an automatic run upon detecting by the media reader the reading action by the personal identification data stored in the personal identification media; (b) connecting to the server of the pre-designated website through the network; (c) upon receiving from the server of the foregoing website the authentication request for the member corresponding to the personal identification data, transmitting to the server of the pre-designated personal information management institution the authentication information input by the user; (d) upon the input of the membership information corresponding to the foregoing personal identification data from foregoing personal information management institution after the stage (c), logging in using the foregoing membership information; and (e) upon the member log-in in the foregoing (d) stage, performing financial services for the account held by the member in connection with the server of the foregoing website.

And this invention may include the storage media that stores the web server program running in the stages of (I) receiving from the user's terminal unit the personal identification data retrieved from the personal identification media to search the database; (II) in case the personal identification data received in the foregoing stage (I) are stored in the foregoing database, conducting log-in using the membership information corresponding to the stored personal identification data to transmit the result to the foregoing user terminal unit; (III) in case the personal identification data received in the foregoing stage (I) are stored in the foregoing database, transmitting the foregoing personal identification data to the personal information management server; and (IV) upon receiving the personal information corresponding to the foregoing personal identification data from the personal information management server after the foregoing stage (III), performing the membership joining process using the personal information received.

### EFFECTS OF THE INVENTION

As has so far been explained, this invention of the online information input and financial transaction system using the personal identification media and the methods to input information online and conduct financial transactions is expected to garner the following effects:

To begin with, it makes the online payment procedure convenient as the system uses the media reader as in an off-line payment.

And due to this online information input and financial transaction system using the personal identification media and the methods to input information online and conduct financial transactions, the personal information registered with the personal information management institution or the personal authentication process provided by the personal information management institution is utilized for the membership joining or log-in process in a general website, helping reduce the time spent for inputting the information required and guarantee an enhance log-in security.

In accordance with this online information input and financial transaction system using the personal identification media and the methods to input information online and conduct financial transactions, the user is to go through the personal authentication process provided by the personal information management institution for membership joining or log-in, requiring no additional authentication or complex payment process to minimize the payment procedure.

And based on this online information input and financial transaction system using the personal identification media and the methods to input information online and conduct financial transactions, the use of financial services can be made more convenient thanks to the simplification of the online financial services or stock trading through the use of the personal identification media and the media reader.

### BRIEF DESCRIPTION OF THE DRAWINGS

The drawing 1, 2, and 3 are the block drawings that, as a specific example of this invention, briefly describe the structure of the online information input and financial transaction system.

The drawing 4 is a block drawing that, as a specific example of this invention, briefly describes the structure of the integrated terminal unit comprising the online information input and financial transaction system.

The drawing 5 is a diagram that, as a specific example of this invention, briefly describes the method of becoming a member of a website using the personal identification media.

The drawing 6 is a diagram that, as a specific example of this invention, briefly describes the method of logging in to a website using the personal identification media.

The drawing 7 is a diagram that, as a specific example of this invention, briefly describes the method of purchasing a product using the personal identification media.

The drawing 8 is a diagram that, as a specific example of this invention, briefly describes a stock trading process using the personal identification media.

The drawing 9 is a diagram that, as a specific example of this invention, briefly describes the method of providing a financial service using the personal identification media.

The drawing 10 is a diagram that, as a specific example of this invention, briefly describes a stock trading process using the personal identification media.

### MODE OF THE INVENTION

From now on, we will explain with the attached drawings the specific examples of how to practice this invention of the online information input and financial transaction system using the personal identification media and the methods to input information online and conduct financial transactions.

The drawing 1, 2, and 3 are the block drawings that, as a specific example of this invention, briefly describe the structure of the online information input and financial transaction system. And the drawing 4 is a block drawing that, as a specific example of this invention, briefly describes the structure of the integrated terminal unit comprising the online information input and financial transaction system.

Specifically, the drawing 1 describes the first example of practicing this invention, and the drawing 2 describes the second example of practicing this invention. The drawing 3 describes the third example of practicing this invention.

More specifically, as described in the drawing 1 or 2, the online information input and financial transaction system as practiced by a specific example comprises the personal terminal unit (10).

Being a general-use PC, the foregoing personal terminal unit (10) may take various forms including a lap-top computer, notebook computer, net book computer, or a mobile terminal. In particular, the foregoing terminal unit (10) is capable of communicating with other terminal units or servers through the wired or wireless connections to the network (N). In this case, the foregoing network may be a network or the Internet. For the system, the foregoing personal terminal unit (10) shall be equipped with a wired or wireless communication module.

This invention of the online information input and financial transaction system as practiced by a specific example comprises the media reader (20). The foregoing media reader (20) is a device that reads the information stored on the magnetic strip, IC chip, RF-IC tag, barcode, and any other storage media containing the electronic authentication certificate installed on the credit card, cash card, USIM chip, etc. In other words, the foregoing identification media can be any information storage media containing the personal information. Therefore, with a data storage media inserted, the foregoing media reader (20) reads the data stored in the media.

The foregoing personal identification media is a means capable of storing or recording a specific amount of data, and it can be any type of portable media that can store or record the personal information registered with the government agencies, financial institutions, personal information management institutions, credit management institutions, or telecommunication companies that keep or manage such personal information as names, addresses, phone numbers, etc. For example, it may include a credit card or a cell phone USIM chip. Parts of the organs of the individuals may also be the personal identification media as people have their distinctive fingerprint, iris, or voice patterns. In this case, the foregoing media reader (20) may be the fingerprint reader, iris reader, or voice recognition device.

As shown in the drawing, the foregoing personal identification media (20) can be connected to the foregoing personal terminal unit as a peripheral device. And as also shown in the drawing 1 and 3, the media reader that reads the data stored in the media can an integrated terminal unit (50) that is integrated to the personal terminal unit.

In this case, the integrated terminal unit (50) has the structure of the general information processing unit, comprising the control (51), storage (52), display (53), input (54), and communication (55) parts, and is equipped with the reading part (56) that reads the data stored in the foregoing identification media. Due to this system structure, the personal identification data can be transmitted to the network (N).

Meanwhile, in case the foregoing media reader (20) is connected to the foregoing personal unit (10) as a peripheral device, which means both are not integrated as one, the foregoing personal terminal unit (10) shall have the input ports, including the USB port, to which the foregoing media reader (20) can be connected, and the device driver can also be stored which will enable the foregoing personal terminal unit (10) to interwork with the foregoing media reader (20). The data on the personal identification media read by the foregoing media reader (20) are transmitted to the network (N) by means of the foregoing personal terminal unit (10).

In the first practicing example of this invention as shown in the drawing 1, the personal terminal unit (10) and the media reader (20) or the foregoing integrated terminal unit (50) connected to it are connected to the network (N), to which the general website server (30) and the server of the information management institution (40) that maintains and manages the personal information corresponding to the personal identification data stored in the personal identification media are connected.

In the second practicing example of this invention as shown in the drawing 2, however, the foregoing personal terminal unit (10) and the foregoing media reader (20) exist as the separate devices, and therefore, the foregoing personal terminal unit (10) does not require the input ports or device driver described in the foregoing. The second practicing example of this invention is different in that the data read by the foregoing media reader (20) are transmitted directly to the network (N′) without going through the foregoing personal terminal unit. In this case, the foregoing personal terminal unit (10) is connected to the general website server through the network (N), and the foregoing media reader (20) is connected to the server of the foregoing personal information management institution through a different network (N′). Meanwhile, both the server of the foregoing website (30) and the server of the foregoing personal information management institution (40) are connected to the same network. The network (N′) in this case, to which the foregoing media reader (20) is connected, can be the value added network (VAN) or the public switched telephone network (PSTN).

Meanwhile, in the third practicing example of this invention as shown in the drawing 3, the foregoing personal terminal unit (10)[0045] and the media reader (20) or the foregoing integrated terminal unit (50) connected to it are connected to the server of the foregoing personal information management institution through the network (N). Unlike the first example, however, the foregoing personal terminal unit (10) and the media reader (20) or the foregoing integrated terminal unit (50) connected to it are not directly connected to the general website server (30) on the network.

The website server (30) in the first or third example of this invention is the one that provides websites to the network (N) including the Internet. The websites provided by the foregoing website server mean a collection of the web pages that provide various services provided on the Internet, including the trading of products, contents or stock. The website server (30) for these services can be the one that manages the websites providing various services including the financial services, and product, stock, and contents trading.

As has been briefly explained in the above, the server of the foregoing personal information management institution (40) is the one operated by the institutions that hold and manage the personal and institutional information corresponding to the personal identification data stored in the personal identification media used for practicing this invention. The server may be the one belonging to the financial institutions, government agencies, authentication organizations or credit management institutions.

The foregoing website server (30) can provide websites to the terminal units connected to the foregoing network (N) through the foregoing network (N)

As such, in the first and second examples of this invention, the foregoing website server (30), with the user of the foregoing personal terminal unit (10) or the foregoing integrated terminal unit (50) connecting to the foregoing network (N) through the foregoing personal terminal unit (10) and requesting the connection to the website provided by the server of the foregoing website (30), transmits the web pages stored in the server of the foregoing website to the foregoing personal terminal unit (10) or the foregoing integrated terminal unit (50). Like this, the user of the foregoing personal terminal unit (10) or the foregoing integrated terminal unit (50) becomes able to be provided with the services that the server of the foregoing website (30).

Meanwhile, the information read by the foregoing media reader (20) is transmitted, in the first example of this invention, to the foregoing personal terminal unit (10), and, in the first example of this invention, directly to the network (N). In the third example of this invention, the information read by the foregoing integrated terminal unit (50) is transmitted to the network. And the personal identification data transmitted is sent to the server of the personal information management institution (40) through the network (N or N′).

In this case, the server of the foregoing personal information management institution (40) becomes able to receive the personal identification data read by the foregoing media reader (20), and conduct the input of the online information and financial transactions as per this invention by transmitting the data required for online information input or the result of financial transactions again to the server of the foregoing website (30).

We have so far explained only the structure of the system for online information input and payment as a specific example of this invention. From now on, we will provide more detailed explanation on the methods of online information input and payment. The following explanations on the methods of online information input and payment will be made in the categories of the first, second and third examples of this invention practiced.

The drawing 5 is a diagram that, as a specific example of this invention, briefly describes the method of becoming a member of a website using the personal identification media, the drawing 6 is a diagram that, as a specific example of this invention, briefly describes the method of logging in to a website using the personal identification media, the drawing 7 is a diagram that, as a specific example of this invention, briefly describes the method of purchasing a product using the personal identification media, and the drawing 8 is a diagram that, as a specific example of this invention, briefly describes a stock trading process using the personal identification media. And the drawing 9 is a diagram that, as a specific example of this invention, briefly describes the method of providing a financial service using the personal identification media and the drawing 10 is a diagram that, as a specific example of this invention, briefly describes a stock trading process using the personal identification media.

To begin with, we will explain the method of becoming a member of a website as a practicing example of this invention. As described in the drawing 5, the method of becoming a member of a website as a practicing example of this invention can be realized by using the system as per the first and second practicing example of this invention.

As described in the drawing 5, the method of becoming a member of a website using the media reader as a specific practicing example of this invention begins with the foregoing personal terminal unit (10) requesting the connection to a specific website (S100). In case the system in the first practicing example of this invention is used, however, the roles of the foregoing personal terminal unit (10) and the media reader (20) connected to it may be replaced by the integrated terminal unit (50) described in the drawing 1.

In the foregoing stage 100, the process is implemented with the user inputting the URL address of the website providing the service he/she wants in the web browser using the foregoing personal terminal unit (10) and requesting for the connection to the network (N). In this case, upon receiving the request for the connection to the website, the foregoing personal terminal unit (10) also transmits the location information of the terminal unit, for example, IP (Internet Protocol) address. Upon receiving the request for the connection to the website, the server of the foregoing website (30) transmits the home page of the foregoing website or specific web pages included in the foregoing website to the foregoing personal terminal unit (10) as per the request for the connection.

With the request for the membership joining-related webpage sent to the server of the foregoing website (30) after the user of the foregoing personal terminal unit (10) selected the membership joining menu on the webpage received, the server of the foregoing website (30) transmits the web page for membership joining to the foregoing personal terminal unit (10). On the webpage for membership joining at the moment, there may be included such hypertext or hyper graphics as asking the user to choose between the method of membership joining through the personal identification media or the general membership joining procedure.

With the user choosing to input information for membership joining using the personal identification media and the personal identification data made to be read by the foregoing media reader (20), the personal identification data read by the foregoing media reader are sent to the server of the personal information management institution (40) through the network (N or N′). (S140)

And the server of the personal information management institution (40) transmits to the server of the foregoing website (30) the personal information of the member of the personal information management institution corresponding to the personal identification data received. (S150)

In the system as per the first practicing example of this invention, the personal identification data read by the foregoing media reader (20) are transmitted to the network (N) through the foregoing personal terminal unit. In transmitting the foregoing personal identification data, the foregoing personal terminal unit (10) can transmit to the network (N) the identification data for the website server that provides the website for membership joining along with the personal identification data. In other words, Upon the occurrence of the personal identification data on the foregoing media reader (20) during the membership joining procedure progressing on the foregoing website provided by the foregoing website server (30), the membership joining application running on the foregoing personal terminal unit (10) loads the identification information of the server of the website providing the website the user wants to join along with the personal identification data before transmitting the personal identification data to the server of the personal information management institution (40). In this wise, the server of the personal information management institution (40) can receive both the personal identification data of the user and the identification information of the server of the website the user wants to join. Accordingly, the server of the personal information management institution (40) can have the stage 100 conducted by sending the personal information of the user corresponding to the personal identification data received to the server of the website (30) identified by the identification information of the server of the website received.

With the personal identification data read by the foregoing media reader (20), the membership joining application running on the foregoing personal terminal unit (10) receives the password for the foregoing personal identification media from the user to transmit to the server of the personal information management institution (40) a collection of the personal identification data, password, and the identification information for the website server, while the server of the personal information management institution (40) can be made to transmit to the server of the foregoing website the personal information of the user of the personal identification media only when the foregoing personal identification data match the foregoing password.

In this case, the foregoing membership joining application could be the membership joining software that is provided in the form of the Active X Controller by the foregoing website server (30) the foregoing personal terminal unit (10) connected to the website provided by the server of the foregoing website (30).

As another method in the system as per the first practicing example of this invention, the foregoing media reader (20), upon reading the personal identification data in the foregoing stage 130, transmits the data to the server of the foregoing personal information management institution (40) using the foregoing personal terminal unit (10), and the server of the foregoing personal information management institution (40) can transmit to the foregoing personal terminal unit (10) the personal information of the member of the personal information management institution corresponding to the personal identification data received. To do this, the membership joining application is run on the foregoing personal terminal unit (10), and the foregoing membership joining application transmits to the server of the foregoing personal information management institution (40) both the personal identification data read by the foregoing media reader (20) and the IP address of the foregoing personal terminal unit (10). Thereafter, with the foregoing personal terminal unit (10) receiving the personal information from the server of the foregoing personal information management institution (40), the personal information received by the foregoing membership joining application is input on the personal information page of the membership-joining webpage provided by the foregoing website server (30). After checking the personal information input, the user causes the foregoing stage 130 or 150 to run by correcting the information, if necessary, and transmitting it to the server of the foregoing website (30). This time, the foregoing membership joining application again transmits the personal identification data read by the foregoing media reader (20) and the IP address of the foregoing personal terminal unit (10) together with the password input by the user, while the server of the foregoing personal information management institution (40) can transmit the personal information of the member to the foregoing personal terminal unit (10) only when the personal identification data received match the password. And when the user checks again the personal information received from the server of the foregoing personal information management institution (40) and transmits it to the server of the foregoing website (30), the IP address of the foregoing personal terminal unit (10) is also transmitted. In this case, the personal information data read can also be transmitted. That the personal identification data are transmitted to the server of the foregoing website (30) along with the personal information is because the personal identification data are to be used in the log-in or payment method that will be explained later.

In the system as per the second practicing example of this invention, before the foregoing media reader (20) reads and transmits the personal identification data to the network (N or N′) in the foregoing stage 130, the server of the foregoing website (30), upon the selection by the user of the membership joining process using the personal identification media in the stage 120, transmits to the foregoing personal terminal unit (10) the webpage indicating the authentication number that is newly allocated whenever the membership joining request is placed using the personal identification media to let the user verify the number. In this case, the server of the foregoing website (30) memorizes the IP address of the personal terminal unit (10) that provided the foregoing authentication number. As explained in the above, the server of the foregoing website (30) provides the foregoing authentication number to the foregoing personal terminal unit (10) and, at the same time, also transmits to the server of the foregoing personal information management institution (40) the request for the personal information including the identification information for the server of the foregoing website (30) and the foregoing authentication number. To enable the server of the foregoing website (30) to transmit the request for the personal information including the identification information for the server of the foregoing website (30) and the foregoing authentication number to the server of the foregoing personal information management institution (40), the server of the foregoing website (30) may in advance conduct the stage of letting the user of the foregoing personal terminal unit (10) select the personal information management institution that provides the personal identification media the user intends to use in the membership joining process.

With the user having the personal identification data read by the foregoing media reader (20) and inputting the foregoing authentication number he/she verified on the webpage into the foregoing media reader (20), the foregoing media reader (20) then conducts the foregoing stage 140 by transmitting both the personal identification data read and the foregoing authentication number to the server of the foregoing personal information management institution (40).

In accordance with the above procedures, the server of the foregoing personal information management institution (40) receives from the server of the foregoing website (30) the foregoing authentication number and the identification information of the server of the foregoing website (30), receives the personal identification information data including the authentication number from the foregoing personal terminal unit (10), and then compares the authentication numbers received from the two sides. If the authentication numbers are the same, then the personal information of the member corresponding to the personal identification data including the authentication number is transmitted to the server of the foregoing website (30) corresponding to the identification information for the server of the website received along with the authentication number. As in the second practicing example of this invention, in case the foregoing personal terminal unit (10) and the foregoing media reader (20) do not connect each other, then the authentication number provided by the server of the foregoing website (30) is used to match the personal identification data read by the foregoing media reader (20) and the user of the foregoing personal terminal unit (10). In accordance with this procedure, the personal information of the member corresponding to the personal identification data is transmitted from the server of the foregoing personal information management institution (40) to the server of the foregoing website (30). Along with the personal information of the member, the personal identification data can be transmitted to the server of the foregoing website (30). In the transmitting the personal information to the server of the foregoing website (30), the server of the foregoing personal information management institution (40) can also transmit the foregoing authentication number to the server of the foregoing website (30), and therefore, the server of the foregoing website (30) becomes able to conduct the membership joining process using the personal information received together with the foregoing authentication number as the personal information corresponding to the user of the personal terminal unit (10) having the stored IP address corresponding to the foregoing authentication number.

Upon receiving the personal information from the server of the foregoing personal information management institution (40) using the first or second practicing sample system of this invention, the server of the foregoing website (30) processes the personal information received to conduct the membership joining process for the user of the foregoing personal terminal unit (10) (S160). This concludes the membership joining process that utilizes the personal identification media.

Meanwhile, in case the regular method of the membership joining procedure is opted instead of the input of the membership joining information using the personal identification media, the server of the foregoing website (30) provides to the personal terminal unit (10) the webpage containing the user interface for inputting the personal information of the member that is often seen in the regular membership joining method (S170). The foregoing user interface for inputting the personal information of the member may include the multiple input blanks for the name, ID, password, phone number, cell phone number, address, resident registration number, company info, and any other related information.

And as the user completes inputting all personal information in each of the input blanks and transmits it to the server of the foregoing website (30), then the server of the foregoing website (30) processes the personal information received to conduct the membership joining procedure for the user of the foregoing personal terminal unit (10) (S180).

In the event the foregoing personal identification media are lost, or the identification information stored in the personal identification media is disclosed to any other person, the server of the foregoing personal information management institution (40) may not transmit the personal information of the member to the server of the foregoing website (30). Or, after the foregoing personal identification media are reissued, or the new identification information is provided, the server of the foregoing personal information management institution (40) may transmit the personal information of the member to a different server of the foregoing website (30).

As shown in the above, the regular membership joining method requires inputting the personal information in each of the input blanks provided in the stage 170, and a large amount of information is required including the member's name, ID, password, phone number, cell phone number, address, resident registration number, company info, and any other related information. Also, the position of the curser should be changed to input the information, and the same goes for the language as the user had to change between English and Korean. In this invention, however, the entire process is competed with the user simply selecting the method of the membership joining using the personal identification media and reading (or depending on the practicing example, imputing the password or authentication number may be added) his/her personal media on the foregoing media reader (20).

Meanwhile, as described in the drawing 6, the method of logging in to a website using the personal identification media is also possible as per the first or second example of this invention. In the case of the first practicing example of this invention, the functions of the foregoing personal terminal unit (10) and the foregoing media reader (20) could be replaced by the foregoing integrated terminal unit (50).

The process begins with the stage (S200) of connecting to the website provided by the server of the foregoing website (30) using the foregoing personal terminal unit (10).

The above-mentioned stage 200 is implemented employing the same method as the stage 100, the website membership joining method using the personal identification media.

With the user afterwards selecting the log-in menu within the website (S210), the server of the foregoing website (30) may enquire the determination between the regular log-in method, which requires direct inputting of the ID and password, and the method of using the personal identification media (S220). If the user selects the latter, the foregoing media reader (20) reads the personal identification data stored on the user's personal identification media to transmit it to the server of the foregoing website (30) (S240).

The server of the foregoing website (30) that received the personal identification data of the user compares the information included in the foregoing personal identification data such as the credit card number with those stored in the server of the foregoing website (30) to search the user information corresponding to the personal identification data received and conduct the log-in of the member (S250), transmitting the result of the log-in to the foregoing personal terminal unit (10).

The procedures running from the stage 230 to the stage 240 are somewhat different in the specific methods of logging on to websites based on the application of the first or second practicing example of this invention.

First, in the website log-in using the personal identification media as per the first practicing example of this invention, the personal identification data read in the stage 230 are transmitted from the foregoing media reader (20) to the foregoing personal terminal unit (10).

And the stage 240 is implemented with the personal identification data received by the foregoing personal terminal unit (10) being sent to the server of the foregoing website.

In the case of a website log-in by means of the information input and financial transaction system using the personal identification media as per the second practicing example of this invention, if the user selects the log-in procedure that uses the personal identification media in the stage 220, the server of the foregoing website (30) transmits to the foregoing personal terminal unit (10) the webpage containing the authentication number that is newly allocated upon each membership joining request using the personal identification media. At the same time, the server of the foregoing website (30) sends the foregoing authentication number and the request signal for the personal identification data to the server of the foregoing personal information management institution (40). In order for the server of the foregoing website (30) to send the foregoing authentication number and the request signal for the personal identification data to the server of the foregoing personal information management institution (40) managed by the personal information management institution that provided the foregoing personal identification media, the server of the foregoing website (30) may, before transmitting the foregoing authentication number, first provide to the foregoing personal terminal unit (10) the interface making the user choose the personal information management institution providing the personal identification media that the user intends to use in the log-in process.

After the user verifies the foregoing authentication number from the foregoing personal terminal unit (10), makes the personal identification data read by the foregoing media reader (20) and inputs the foregoing authentication number to transmits the data, the personal identification data read by the foregoing media reader (20) in the stage 230 and the foregoing authentication number are transmitted to the server of the foregoing personal information management institution (40) through the network (N or N′), completing the stag 230.

Upon receiving the personal identification data and the foregoing authentication number, the foregoing personal information management institution (40) compares the request signals for the personal identification data and the foregoing authentication number received from the server of the foregoing website (30) and transmits the personal identification data received to the server of the foregoing website (30) only when the two authentication numbers match each other. The stage 240 proceeds accordingly.

As explained in the above, upon receiving the personal identification data, the server of the foregoing website (30) conducts the log-in procedure using the user information which is the same as the personal identification data received and corresponding to the personal identification data to transmit the result the foregoing personal terminal unit (10) (S250).

Meanwhile, in case the user does not select the log-in method using the personal identification media the server of the foregoing website (30) provides such webpage as enabling the user to input the ID and password as in a regular method (S260) and processes the information input to conduct the log-in procedure (S270).

In the event the foregoing personal identification media are lost, or the identification information stored in the personal identification media is disclosed to any other person, the server of the foregoing website (30) may receive in advance such information from the server of the foregoing personal information management institution (40), blocking the log-in by the personal identification media lost or the identification information disclosed.

When comparing the log-in method as per the practicing example of this invention and the regular long-in method, the log-in method using the personal identification media conducts the log-in process by having the user read and transmit the personal identification data using the foregoing media reader (20) or additionally input the authentication number, while, in the regular long-in method, the ID and password are directly transmitted. In this sense, the new method may not be considered by far convenient compared to the traditional method, but the former is convenient in that the user does not have to worry about the ID or password lost, and with a supplementary authentication process including transmitting the secret number for the credit card along with the personal identification data, the user does not have to input the personal identification information again or go though complex authentication for the payment process. In other words, with the user going through the supplementary password input and personal authentication process in the log-in method using the personal identification media, then the user only have to select the product and place the purchase request as the server of the foregoing website (30) requests for payment to the server of the foregoing personal information management institution (40) using the personal identification data used for the log-in to complete the payment process.

Meanwhile, as described in the drawing 7, the product purchasing method using the personal identification media can be realized by means of both the first and second practicing example of this invention. But in the product purchasing method as per this invention, such media issued by the financial institutions as a credit card or a debit card are appropriate for the foregoing identification media. This is because the payment process is involved in the procedure.

In the product purchasing method as per the first practicing example of this invention, the purchasing process begins with the user connecting to the website provided by the server of the foregoing website (30) on the foregoing personal terminal unit or the foregoing website server (S300).

Now the next stage (S310) begins in which the user selects at least one of the products posted on any webpage included in the foregoing website and determines the quantity, etc. on the foregoing personal terminal unit (10) or the foregoing integrated terminal unit (50).

Then the user reads the personal identification data through the foregoing media reader (20) or the reading part installed in the foregoing integrated terminal unit (50)(S320), and the personal identification data read in the stage 320 and the product purchasing information from the stage 310 are transmitted to the foregoing personal information management institution (40) (S330).

As per the process, the server of the foregoing personal information management institution (40) implements the payment process corresponding to the foregoing personal identification data based on such information included in the product purchase information as the price, quantity, installments, etc., and the personal information of the member (for example, name, phone number, address, email address, etc.) corresponding to the foregoing personal identification data may be transmitted to the server of the foregoing website (30) along with the payment result. However, the foregoing stage 340 is not obligatory, and intended for the personal information to be transmitted from the server of the foregoing personal information management institution (40) to the server of the foregoing website (30) to ensure the delivery of the product sold in a purchase without the log-in process.

Thereafter, the server of the foregoing website (30) receives the payment result to have the result output on the foregoing personal terminal unit ([0092]10), and stores the personal information of the member received from the server of the foregoing personal information management institution (40) to let the information used for the delivery of the product, completing the purchase process (S350).

But in the case of employing the first practicing example system referring to the drawing 1, the stage 330 is completed with the personal identification data read by the foregoing media reader (20) in the foregoing stage 320, product purchase information, the personal identification information of the server of the foregoing website (30) from which the product is purchased being directly sent to the server of the foregoing personal information management institution (40), and thereafter the server of the foregoing personal information management institution (40) implements the foregoing stage 340. Or, the personal identification data read by the foregoing media reader (20) and the product purchase information are transmitted to the server of the foregoing website (30) through the foregoing personal terminal unit (10), and the server of the website (30) that received them may transmit the personal identification data, the product purchase information, and the identification information of the server of the website from which the product is purchased again to the server of the foregoing personal information management institution (40). Or, the foregoing personal terminal unit (10) transmits the personal identification data and the identification information (for example, IP address) of the foregoing personal terminal unit to the server of the foregoing personal information management institution (40), and the server of the website (30) sends the product purchase information, the identification information of the foregoing server of the website (30), and the identification information of the foregoing personal terminal unit (10) from which the product is purchased to the server of the foregoing personal information management institution (40) to enable the server of the foregoing personal information management institution (40) to match the identification information of the foregoing personal terminal unit (10) with the personal identification data and the product purchase information to conduct the payment process.

Meanwhile, in the case of employing the second practicing example system referring to the drawing 2, the product purchasing process begins with the user connecting to the website provided by the server of the foregoing website (30) on the foregoing personal terminal unit (10) (S300).

And then the next stage begins in which the user selects at least one of the products posted on any webpage included in the foregoing website and determines the quantity, etc. on the foregoing personal terminal unit (10) (S310).

Then the user reads the personal identification data through the foregoing media reader (20) or the reading part installed in the foregoing integrated terminal unit (50)(S320). In this foregoing stage 320, before transmitting the personal identification data read by the foregoing media reader (20), the server of the foregoing website (30), upon the selection of the product purchase in the stage 310, receives the information on the personal information management institution that provided the personal identification media the user of the foregoing personal terminal unit (10) intends to use, transmits the authentication number to the foregoing personal terminal unit (10), and provides the authentication number, the identification information of the server of the foregoing website (30), and the product purchase information to the server of the foregoing personal information management institution (40)

And the personal identification data read in the stage 320 and the product purchasing information from the stage 310 are transmitted to the server of the foregoing personal information management institution (40) (S330). At this time, the user inputs the foregoing authentication number to the foregoing media reader (20) to transmit the foregoing authentication number along with the personal identification data to the server of the foregoing personal information management institution (40). The server of the foregoing personal information management institution (40) accordingly receives the personal identification data and the authentication number from the foregoing media reader (20) and also receives the identification information, the product purchase information and the foregoing authentication number from the server of the foregoing website (30) to complete the stage 330.

Using the information received in the foregoing stage 330, the server of the foregoing personal information management institution (40), if the authentication number received from the foregoing media reader (20) and the authentication number received from the server of the foregoing website (30) match each other, conducts the payment procedures for the product prices using the personal identification data and the product purchase information received together with the matching authentication number, and transmits the personal information of the member corresponding to the personal identification data and the payment result to the server of the foregoing website (30) to complete the stage 340.

Upon receiving the payment result, the server of the foregoing website (30) causes the foregoing personal terminal unit (10) to output the payment result, stores the member's personal information received from the server of the foregoing personal information management institution (40) to use for the delivery of the product, completing the product purchasing process (S350).

As per the online product purchasing method using the personal identification media as a practicing example of this invention, the payment for the product purchased and the input of the delivery-related information can be made without inputting the complex personal identification media information or the delivery-related information, and the personal authentication and payment can also be made without the membership joining or log-in process.

Similarly to this product purchasing method, the stock buying and selling as a practicing example of this invention, as shown in the drawing 8, begins with the stage in which the online stock trading program begins to run on the foregoing personal terminal unit (10) (S400). The stock trading method as shown in the drawing 8 can be run by the system based on the first or second practicing example of this invention. In the first practicing example of this invention, the process implemented by the foregoing personal terminal unit (10) and the foregoing media reader (20) can also be implemented by the foregoing integrated terminal unit (50).

The foregoing online stock trading program refers to such program provided in the form of a downloadable one from the online stock trading website by the server of the foregoing website (30).

After the user of the foregoing personal terminal unit (10) selects and inputs such information as the stock name, quantity, price, etc. (S140) using the foregoing online stock trading program, and selects the buying or selling of the stock (S420), then such information input is transmitted t the server of the foregoing website (30).

Meanwhile, after the personal identification data are read by the foregoing media reader (20) (S340), the read personal identification data and stock trading information are transmitted to the server of the foregoing personal information management institution (40) (S440), and the server of the foregoing personal information management institution (40) performs the payment procedure. In the case of a stock selling, the account information of the member corresponding to the personal identification data received is transmitted to the server of the foregoing website (30) (S450)

Stock buying or selling process progresses in accordance with the payment result on the foregoing website server (30) and the stock buying and selling procedures become complete with the result of the progress reflected on the current stock holding status and transmitted to the foregoing personal terminal unit (10).

There is also a little difference in the specific form of the practicing system between the first and second practicing examples of this invention. First, in the case of the first practicing example, the foregoing personal terminal unit (10) can receive the personal identification data read by the foregoing media reader (20) and transmit the data, stock trading information and the identification information of the server of the foregoing website (30) that provided the foregoing online stock trading program to the server of the foregoing personal information management institution (40), or the foregoing personal terminal unit (10) can transmit such data and stock trading information to the server of the foregoing website (30), while the server of the foregoing website (30) that received can transmit such data and information to the server of the foregoing personal information management institution (40). Or, the foregoing personal terminal unit (10) can transmit the personal identification data and the identification information of the foregoing personal terminal unit (10) to the server of the foregoing personal information management institution (40), and the server of the foregoing website transmits the stock trading information, the identification of the server of the foregoing website (30), and the identification information of the foregoing personal terminal unit (10) to the server of the foregoing personal information management institution (40), while the server of the foregoing personal information management institution (40), if the information received from foregoing personal terminal unit and the personal terminal unit (10) identification information included in the information received from the server of the foregoing website (30) match each other, performs the payment procedure required for the stock buying or selling using the personal identification data received together with the match personal terminal unit (10) identification information and stock trading information, and, in the case of a stock selling, transmits the payment account-related information corresponding to the personal identification data received to the server of the foregoing website (30).

Meanwhile, in the case of the second practicing example as shown in the drawing 2, the server of the foregoing website (30), upon the implementation of the stage 420, provides the authentication number to the foregoing personal terminal unit (10), and the user causes the foregoing authentication number and the foregoing personal identification data to be simultaneously transmitted from the foregoing media reader (20) to the server of the foregoing personal information management institution (40) by transmitting the authentication number provided along with the personal identification data on the foregoing media reader (20). And with the foregoing website server (30) transmitting the same authentication number, the stock trading information selected on the foregoing personal terminal unit (10), and the identification information of the foregoing website server (30) to the server of the foregoing personal information management institution (40), the server of the foregoing personal information management institution (40) becomes able to receive from the foregoing media reader (20) and the foregoing website server (30) the matching authentication number, the personal identification data, the stock trading information, etc.

The above example applies to a case in which the entity providing stock trading services and the entity managing the personal identification media used by the user are the different ones. For reference, the stock trading method later explained by the drawing 10 only applies to the case in which the entity providing stock trading services and the entity managing the personal identification media used by the user are the same ones.

The online stock trading method using the personal identification media as a practicing example of this invention has an advantage that a stock trading can be performed without having to open a separate stock trading account or inputting any separate user information.

Meanwhile, whether it be the first or third practicing example of this invention, the method of providing financial services as a practicing example of this invention can be realized in a system in which the personal terminal unit (10) or the integrated terminal unit (50) is directly connected to the server of the foregoing personal information management institution (40) through the network. In this practicing example, the server of the foregoing personal information management institution (40) becomes the one that provides the individual-proper personal identification data stored in the foregoing personal identification media by keeping and managing the personal information of the member and, at the same time, the one that provides financial services including wire transfers, account checking, loans, and utility bill payment. For example, the server of the foregoing personal information management institution (40) in the practicing example could be the administrative server of the credit card companies or banks and the foregoing personal identification media could be a credit card or debit card.

The method of providing financial services as a practicing example of this invention as described in the drawing 9 begins with the stage in which the personal identification data stored in the foregoing personal identification media are read by the foregoing media reader (20) connected to the foregoing personal terminal unit (10) or the reading part (56) of the foregoing integrated terminal unit (50) (S500).

As the personal identification data of the specific personal identification media are read in the foregoing stage 500, the operating system of the foregoing personal terminal unit (10) or the foregoing media reader (20) detects the data to run the financial service application corresponding to those provided by the financial institutions that issued the very personal identification media (S510). The financial service application in this case is the one that is stored from the storage device or the network to the foregoing personal terminal unit (10) or the foregoing media reader (20), and is the online operating application that operates through online connection as the structure corresponding to the server of the foregoing personal information management institution (40).

As the foregoing financial service application is automatically run in the stage 510, the foregoing personal terminal unit (10) or the foregoing integrated terminal unit (50) is automatically connected to the server of the foregoing personal information management institution (40) that corresponds to the server of the financial institutions. And the personal identification data that are read immediately upon the connection are transmitted to the server of the foregoing personal information management institution (40).

The server of the foregoing personal information management institution (40) that received the foregoing personal identification data performs the authentication procedure using the member's personal information corresponding to the personal identification data received (S520). In other words, the server compares such personal information as the credit card password, expiration date, or CVC code received from the foregoing personal terminal unit (10) or the foregoing integrated terminal unit (50) with the information stored in the server of the foregoing personal information management institution (40).

With the authentication procedure successfully completed in the foregoing stage 520, then the financial services provided by the financial service application such as the account or payment check, wire transfer, loan, or utility bill payment are to be implemented (S54).

And as shown in the drawing 10, the stock trading method as a practicing example of this invention, as in the first or third practicing example, can be realized in the system in which the personal terminal unit (10) or the integrated terminal unit (50) is directly connected to the server of the foregoing personal information management institution (40) through the network. In this practicing example explained based on the drawing 10, the server of the foregoing personal information management institution (40) becomes the one that provides the individual-proper personal identification data stored in the foregoing personal identification media by keeping and managing the personal information of the member and, at the same time, the one that provides the stock trading services including the current holdings check, buys, and sells. And the foregoing personal identification media could be the stock trading account card issued by the foregoing personal information management institution.

In the stage 600, the personal identification data stored in the foregoing personal identification media are read by the foregoing media reader (20) connected to the foregoing personal terminal unit (10) or the reading part (56) of the foregoing integrated terminal unit (50).

As the personal identification data of the specific personal identification media are read in the foregoing stage 600, the operating system of the foregoing personal terminal unit (10) or the foregoing media reader (20) detects the data to run the stock trading application corresponding to those provided by the stock broker companies (S610). The stock trading application in this case is the one that is stored from the storage device or the network to the foregoing personal terminal unit (10) or the foregoing media reader (20), and is the online operating application that operates through online connection as the structure corresponding to the server of the foregoing personal information management institution (40).

As the foregoing stock trading application is automatically run in the stage 610, the foregoing personal terminal unit (10) or the foregoing integrated terminal unit (50) is automatically connected to the server of the foregoing personal information management institution (40) through the network. And the personal identification data that are read immediately upon the connection are transmitted to the server of the foregoing personal information management institution (40).

The server of the foregoing personal information management institution (40) that received the foregoing personal identification data performs the authentication procedure using the member's personal information corresponding to the personal identification data received (S620). In other words, the server compares such personal information as the credit card password received from the foregoing personal terminal unit (10) or the foregoing integrated terminal unit (50) with the information stored in the server of the foregoing personal information management institution (40).

With the authentication procedure successfully completed in the foregoing stage 620, then the stock trading services provided by the stock trading application such as the account check, buying or selling are to be implemented (S640).

In the practicing examples of this invention as explained based on the drawing 9 and 10, the stock trading services are automatically run with the user causing the information stored in the personal identification media to be read, and, therefore, the user does not have to go through the complex log-in procedure or input the account information or the card number, enabling the user to conveniently receive financial or stock trading-related services.

The rights to this invention shall not be limited to the practicing examples described in the above, and shall be defined as prescribed in The Scope of the Claims. It is apparent that the one that has the general knowledge in the area of this invention shall be able to cause various changes or modifications to be made within the scope of the claims.

1. An online information input and financial transaction system using personal identification media that consists of at least one personal terminal unit that is connected to the network and capable of communicating with servers connected to the network; at least one media reader that is installed to the foregoing network and retrieves and transmits personal identification data stored in the personal identification media to the foregoing personal terminal unit; at least one website server that provides web pages contained in a website to at least one personal terminal unit; and a server of personal information management institution that stores member's personal information corresponding to the foregoing personal identification data and conducts the payment procedure for the designated member upon receiving the payment request from the foregoing website, wherein upon receiving from the foregoing personal terminal unit the personal identification data retrieved by the foregoing media reader, the foregoing website server compares and searches the personal identification data that match the personal identification data already stored in the server of the foregoing website, and conducts the membership log-in procedure provided by the server of the foregoing website by using the personal membership information corresponding to the personal identification data searched, and in the event no personal identification data received from the foregoing personal terminal unit is found among the personal identification data already stored in the server of the foregoing website, then the system transmits the request for the foregoing personal identification data and the personal membership information corresponding to the foregoing personal identification data to the server of the foregoing personal information management institution, and conducts the membership log-in procedure by using the personal membership information received from the foregoing personal information management institution, whereas, upon receiving the request for the foregoing personal identification data and the personal membership information corresponding to the foregoing personal identification data from the foregoing website, the server of the personal information management institution provides the personal membership information corresponding to the foregoing personal identification data to the server of the foregoing website.

2. The online information input and financial transaction system using the personal identification media according to claim 1, in which, in case no personal identification data received is found among the personal identification data already stored in the server of the foregoing website, then the server of the foregoing website receives the password corresponding to the very personal identification data from the foregoing personal terminal unit, transmits to the server of the foregoing personal information management institution the foregoing password together with the foregoing personal identification data and the personal membership information corresponding to the foregoing personal identification data, whereas the server of the foregoing personal information management institution can provide to the foregoing website the personal membership information corresponding to the foregoing personal identification data only when the password match that of the personal identification data received.

3. The online information input and financial transaction system using the personal identification media according to claim 1 in which, the server of the foregoing website receives from the foregoing personal terminal unit the personal identification data and the password matching that of the foregoing personal identification information retrieved from the foregoing personal terminal unit, transmits to the server of the personal information management institution the personal authentication request including the foregoing personal identification data and the foregoing password, conducts the membership log-in procedure only when the personal authentication is successfully completed by the server of the personal information management institution, whereas the server of the personal information management institution may transmit the result of the personal authentication to the foregoing website server after receiving the foregoing personal identification data and the foregoing password from the server of the foregoing website and conducting the personal authentication process.

4. The online information input and financial transaction system using the personal identification media according to claim 3 in which, upon receiving a product purchase order from the foregoing personal terminal unit, the server of the foregoing website transmits the server of the personal information management institution the information related to the purchase case including the price and installment period, the foregoing personal identification data, and the foregoing password to request payment for the case, whereas the server of the personal information management institution makes payment using the information related to the purchase case, the foregoing personal identification data, and the foregoing password and may transmit the result of the payment to the foregoing website server.

5. An online information input and financial transaction system using the personal identification media that consists of at least one personal terminal unit that is directly connected to the first network and capable of communicating with the servers connected to the first network; at least one media reader that is directly connected to the second network and capable of communicating with the servers connected to the second network, and retrieves the personal identification data stored in the personal identification media; at least one website server that provides the web pages contained in the websites to at least one personal terminal unit; and the server of the personal information management institution that stores the member's personal information corresponding to the foregoing personal identification data and conducts the payment procedure for the designated member upon receiving the payment request from the foregoing website, wherein upon receiving from the foregoing personal terminal unit either the membership joining request, log-in request, or payment request, the server of the foregoing website transmits the webpage and authentication number for the selection of the personal information management institution, and, upon the selection of the agency by the foregoing personal terminal unit, transmits either the membership joining request, log-in request, or payment request along with the authentication number to the server managed by the personal information management institution selected. Meanwhile, upon receiving from the foregoing website server either the personal information request, personal authentication request, or payment request along with the authentication number, and the personal identification data and the authentication number from the foregoing media reader, the server of the foregoing personal information management institution, in case the authentication number received from the foregoing website server matches the number received from the foregoing media reader, accepts either the personal information request, personal authentication request, or payment request using the personal identification data transmitted along with the matching authentication number to conduct the responsive payment process and may transmit to the foregoing website either the personal information, the result of the personal authentication, or the payment result.

6. The online information input and financial transaction system using the personal identification media according to claim 5 in which, the server of the foregoing personal information management institution receives from the foregoing media reader the foregoing personal identification data, the foregoing authentication number and the password corresponding to the foregoing personal identification data, and accepts either personal information request, personal authentication request, or payment request to conduct the responsive process only when the foregoing personal identification data match the foregoing password.

7. The online information input and financial transaction system using the personal identification media according to claim 5 or claim 6 in which, the foregoing first network as used herein may refer to the Internet, and the foregoing second network may refer to the Internet, VAN (Value Added Network) or PSTN (Public Switched Telephone Network).

8. An online information input and financial transaction system using the personal identification media which may be performed in the stages of (A) receiving either the membership joining request, request for the change to the member information, or log-in request from the personal terminal unit; (B) receiving from the foregoing personal terminal unit the personal identification data retrieved by the media reader and the password corresponding to the foregoing identification data; (C) transmitting to the server of the foregoing personal information management institution the personal identification data and password received, and the request for the personal information or the personal authentication; and (D) upon receiving the personal information or the result of the personal authentication from the server of the foregoing personal information management institution, conducting the membership-joining or member information change procedures using the personal information received or conducting a log-in only when the personal authentication is successfully completed.

9. The online information input and financial transaction system using the personal identification media in which the methods of inputting the foregoing online information and conducting financial transactions may be performed in the stages of (E) receiving a purchase order from the foregoing personal terminal unit; (F) determining the current logged-in/logged-out status of the foregoing personal terminal unit that placed the purchase order; (G) in case the foregoing personal terminal unit is in a logged-in status, transmitting to the server of the foregoing personal information management institution the payment request including the personal identification data and password received in the foregoing (B) stage, and the payment-related information such as the price and installment period; (H) in case the foregoing personal terminal unit is in a logged-out status, receiving from the foregoing personal terminal unit the personal identification data and the password corresponding to the foregoing personal identification data; (I) transmitting to the server of the foregoing personal information management institution the payment request including the personal identification data and password received in the foregoing (H) stage, and the payment-related information such as the price and installment period; and (J) in response to the payment request transmitted in the foregoing (G) or foregoing (I) stage, reflecting the result of the product purchase as per the payment result received from the server of the foregoing personal information management institution and transmitting the purchase result to the foregoing personal terminal unit.

10. The online information input and financial transaction system using the personal identification media according to claim 9 in which, in the foregoing stage (I), adding to the foregoing request for payment, the request for the personal information including the name and address of the member corresponding to the foregoing personal identification data is also transmitted, and, in the foregoing stage (J), the personal information of the member received together with the result of the foregoing payment result may be reflected as the delivery information upon the result of the product purchase only in case the foregoing request for the personal information is transmitted to the server of the foregoing personal information management institution.

11. An online information input and financial transaction system using the personal identification media which may be performed in the stages of (1) receiving by the server of the foregoing website the request for either membership joining, change of the member information, or log-in from the personal terminal unit; (2) upon receiving the request for either membership joining, change of the member information, or log-in from the foregoing personal terminal unit, transmitting by the server of the foregoing website to the personal terminal unit the webpage and authentication number that enable the selection of the personal information management institution; (3) transmitting to the server of the foregoing personal information management institution the information including the personal identification data retrieved from the media reader, the password corresponding to the foregoing personal identification data, and the authentication number; (4) transmitting to the server of the personal information management institution the request for the personal information or the personal authentication that include the same authentication number as the one the foregoing website server provided to the foregoing personal terminal unit in the foregoing (2) stage; (5) in case the authentication number included in the information the server of the personal information management institution received from the foregoing media reader matches the authentication number received from the foregoing website server, providing the personal information or the result of the personal authentication to the server of the foregoing webpage after searching the personal information of the member using the personal identification data and password included in the information matching the authentication number or conducting the personal authentication process; and (6) conducting by the server of the foregoing website the membership joining, member information change or log-in procedures based on the personal information or the result of the personal authentication.

12. The online information input and financial transaction system using the personal identification media according to claim 11 which may be performed in the stages of (7) receiving by the server of the foregoing website the purchase order from the foregoing personal terminal unit; (8) determining by the server of the foregoing website the current logged-in/logged-out status of the foregoing personal terminal unit that placed the purchase order; (9) in case the foregoing personal terminal unit is in a logged-in status, transmitting by the server of the foregoing website to the server of the foregoing personal information management institution the payment request including the personal identification data and password received in the foregoing (3) stage, and the payment-related information such as the price and installment period; (H) in case the foregoing personal terminal unit is in a logged-out status, transmitting by the server of the foregoing website to the personal terminal unit the webpage and authentication number for the selection of the personal information management institution; (11) after the completion of the foregoing stage (10), transmitting to the server of the foregoing personal information management institution the information including the personal identification data retrieved from the media reader, the password corresponding to the foregoing personal identification data, and the authentication number; (12) transmitting to the server of the foregoing personal information management institution the same authentication number as the one the foregoing website server provided to the foregoing personal terminal unit in the foregoing stage (10) and the payment request that include the payment-related information such as the price and installment period; (13) in case the authentication number included in the information the server of the personal information management institution received from the foregoing media reader in the foregoing stage (11) matches the authentication number received from the foregoing website server in the foregoing stage (12), providing the payment result to the server of the foregoing webpage after conducting the payment process using the personal identification data and password included in the information matching the authentication number; and (14) reflecting by the server of the foregoing website the result of the product purchase as per the payment result received from the server of the foregoing personal information management institution and transmitting the purchase result to the foregoing personal terminal unit.

13. An online information input and financial transaction system using the personal identification media that consists of at least one personal terminal unit that is directly connected to the network and capable of communicating with the servers connected to the network; the media reader that is installed to the foregoing personal terminal unit and retrieves and transmits the personal identification data stored in the personal identification media to the foregoing personal terminal unit; the website server that provides the web pages contained in the websites to the foregoing personal terminal unit; and the server of the personal information management institution that stores the member's personal information corresponding to the foregoing personal identification data. With the foregoing media reader detecting the personal identification data stored in the personal identification media, the foregoing personal terminal unit can connect to the server of the foregoing website and automatically run the application provided from the server of the foregoing website, and, running on the application, transmit to the server of the foregoing personal information management institution the personal identification data retrieved by the foregoing media reader and the authentication information input by the user.

14. The online information input and financial transaction system using the personal identification media according to claim 13 in which the server of the foregoing personal information management institution can conduct the authentication process by comparing the personal information already stored and the authentication information transmitted from the foregoing personal terminal unit for the member corresponding to the foregoing personal identification data transmitted from the foregoing personal terminal unit.

15. The online information input and financial transaction system using the personal identification media according to claim 14 in which, after the authentication process by the server of the foregoing personal information management institution, the foregoing personal terminal unit interworks with the server of the foregoing website as per the application to provide to the user the financial services that include at least one out of the bank account statement, remittances, payments, credit card statement, and cash advance services.

16. The online information input and financial transaction system using the personal identification media according to claim 14 in which, after the authentication process by the server of the foregoing personal information management institution, the foregoing personal terminal unit interworks with the server of the foregoing website as per the application to provide to the user the stock trading services including the current holdings check, buys, and sells.

17. Storage media that stores the personal terminal unit-based program running in the stages of (a) an automatic run upon detecting by the media reader the reading action by the personal identification data stored in the personal identification media; (b) connecting to the server of the pre-designated website through the network; (c) upon receiving from the server of the foregoing website the authentication request for the member corresponding to the personal identification data, transmitting to the server of the pre-designated personal information management institution the authentication information input by the user; (d) upon the input of the membership information corresponding to the foregoing personal identification data from foregoing personal information management institution after the stage (c), logging in using the foregoing membership information; and (e) upon the member log-in in the foregoing (d) stage, performing financial services for the account held by the member in connection with the server of the foregoing website.

18. Storage media that stores the web server program running in the stages of (I) receiving from the user's terminal unit the personal identification data retrieved from the personal identification media to search the database; (II) in case the personal identification data received in the foregoing stage (I) are stored in the foregoing database, conducting log-in using the membership information corresponding to the stored personal identification data to transmit the result to the foregoing user terminal unit; (III) in case the personal identification data received in the foregoing stage (I) are stored in the foregoing database, transmitting the foregoing personal identification data to the personal information management server; and (IV) upon receiving the personal information corresponding to the foregoing personal identification data from the personal information management server after the foregoing stage (III), performing the membership joining process using the personal information received.

19. In relation to the claim 1 or claim 5, the online information input and financial transaction system using the personal identification media in which, the foregoing personal identification media could be either the information storage means or any part of the human body that may be distinguished from that of others.
